(19) United States
(12) Patent Application Publication
(10) Pub. No.: US 2011/0156685 A1
(43) Pub. Date: Jun. 30, 2011

(54) CONSTANT TIME BUCK-BOOST SWITCHING REGULATOR AND CONTROL CIRCUIT AND METHOD FOR THE SAME

(75) Inventors: Wen-Wei Chen, Luzhou City (TW); Kuo-Chi Liu, Hsinchu City (TW)

(73) Assignee: Richtek Technology Corporation, R.O.C.

(21) Appl. No.: 12/648,412

(22) Filed: Dec. 29, 2009

(51) Int. Cl. G05F 1/618

(52) U.S. Cl. 323/284

(57) ABSTRACT

The present invention discloses a constant time buck-boost switching regulator, and a control circuit and a method for controlling the buck-boost switching regulator. The buck-boost switching regulator includes an inductor, a first and a second power switches coupled to a first end and a second end of the inductor respectively, and a first and a second power devices coupled to the first end and the second end of the inductor respectively, the first power switch being coupled between the first end of the inductor and an input voltage, the second power switch being coupled between the second end of the inductor and ground, the first power device being coupled between the first end of the inductor and ground, and the second power device being coupled between the second end of the inductor and an output voltage. The control method comprises: generating only one single constant time; and generating a switch control signal to control the first and second power switches such that the first and second power switches operate by the same switching period with the same ON-time.

### BACKGROUND OF THE INVENTION

1. Field of Invention

The present invention relates to a constant ON-time or a constant OFF-time buck-boost switching regulator; particularly, it relates to a current mode or a voltage mode switching regulator which only needs to generate one set of constant time. The present invention also relates to a control circuit and a control method for the switching regulator.

2. Description of Related Art

Referring to FIG. 1, U.S. Pat. No. 6,166,527 discloses a method for controlling a buck-boost switching regulator. The buck-boost switching regulator comprises an inductor L, four power switches A, B, C, and D, and a control circuit 20. The control circuit 20 controls the switching operations of the four power switches A, B, C, and D to convert an input voltage Vin to an output voltage Vout. The input voltage Vin may be higher or lower than the output voltage Vout, and therefore the regulator should be able to perform both buck and boost conversions. In the control circuit 20, an error amplifier 22 compares a feedback signal FB (indicating information relating to the output voltage Vout) with a reference voltage Vref, and generates an error amplified signal Vea. Pulse width modulation (PWM) comparators 24 and 25 compare the error amplified signal Vea with signals VX and VY respectively, and a logic circuit 29 generates switching control signals VA, VB, VC, and VD to respectively control the power switches A, B, C, and D according to the comparison by the PWM comparators 24 and 25.

The relationships among the error amplified signal Vea, the voltage wave signals VX and VY, and the switching control signals VA, VB, VC, and VD are shown in FIG. 2. When the error amplified signal Vea is between V1 and V2, the regulator operates in a buck conversion mode. When the error amplified signal Vea is between V2 and V3, the regulator operates in a buck-boost conversion mode. When the error amplified signal Vea is between V3 and V4, the regulator operates in a boost conversion mode. When the regulator is operating in the buck conversion mode, the power switch C is kept off and the power switch D is kept on. When the regulator is operating in the boost conversion mode, the power switch A is kept on and the power switch B is kept off. When the regulator is operating in the buck-boost conversion mode, as shown in the FIG. 2, the switching control signals VA and VB are generated according to the relationship between the error amplified signal Vea and the voltage wave signal VX, and the switching control signals VC and VD are generated according to the relationship between the error amplified signal Vea and the voltage wave signal VY; in other words, the regulator performs a combination of boost conversion (the power switches C and D operating) and buck conversion (the power switches A and B operating).

The aforementioned prior art is characterized in that all the power switches A, B, C, and D operate according to the feedback signal FB all the time. Such arrangement has a drawback that, as shown in FIG. 2, when the error amplified signal Vea intersects with the signal VX by a very small period, the switching control signals VA and VB are still generated and the power switches A and B are still operating. This causes switching losses and increases the power consumption. The same occurs when the error amplified signal Vea intersects with the signal VY by a very small period.

FIG. 3 shows the circuit structure of another prior art U.S. Pat. No. 7,176,667. This prior art uses the error amplifier 22 to generate two error amplified signals Veal and Veal, one of which is selected to be compared with a voltage waveform signal OSC in the PWM comparators 24. The circuit further includes a fixed pulse width signal generation circuit 26; based on the outputs from the PWM comparator 24 and the fixed pulse width signal generation circuit 25, the logic circuit 29 generates the switching control signals VA, VB, VC, and VD to control the power switches A, B, C, and D respectively.

Referring to FIG. 4, there are four conversion modes in U.S. Pat. No. 7,176,667: besides the buck conversion mode M1 and the boost conversion mode M4, a transient buck conversion mode M2 and a transient boost conversion mode M3 are provided between M1 and M4. The switching control signals VA and VB follow the output of the PWM comparators 24 and the switching control signals VC and VD are fixed pulse width in the transient buck conversion mode M2. The switching control signals VC and VD follow the output of the PWM comparators 24 and the switching control signals VA and VB are fixed pulse width in the transient boost conversion mode M3.

The aforementioned prior art has the following drawbacks: four conversion modes require more complicated control mechanism; additional fixed pulse width signal generation circuit 26 and other circuit devices are required; and with the two transition modes (M2 and M3) it means that there is more chance for the circuit to operate in the transient modes, but all the four power switches are operating in the transient modes, increasing the switching loss and the power consumption.

U.S. Pat. No. 7,518,346 discloses another prior art. The basic structure of this prior art is similar to the prior art shown in FIG. 1, but the signals VX and VY have different waveforms. As shown in FIG. 5, the directions of the signals VX and VY are not in-phase in the U.S. Pat. No. 7,518,346. In addition, this patent also discloses modified boost ramp waveforms VY1 and VY2.

U.S. Pat. No. 7,466,112 discloses another prior art as shown in FIG. 6. A sense resistor Rsense is connected to the lower end of the power switches B and C. Sense signals obtained from two ends of the sense resistor Rsense are inputted to the PWM comparators 24 and 25, so as to make the ON time of the power switches A and D as long as possible.

All the above prior art circuits require complicated control circuits and mechanisms for controlling the four power switches, and are less desired.

### SUMMARY OF THE INVENTION

A first objective of the present invention is to provide a buck-boost switching regulator with a relatively simple circuit and mechanism compared to the prior art circuits.

A second objective of the present invention is to provide a control circuit for controlling the buck-boost switching regulator.

A third objective of the present invention is to provide a method for controlling the buck-boost switching regulator.

To achieve the objectives mentioned above, from one perspective, the present invention provides a constant time buck-boost switching regulator comprising: an inductor having a first end and a second end; a first power switch having one end coupled to the first end of the inductor and another end coupled to an input voltage; a second power switch having one end coupled to the first end of the inductor and another end coupled to ground, the first and second power switches operating in opposite phases to each other; a third power switch having one end coupled to the second end of the inductor and another end coupled to ground; a fourth power switch having one end coupled to the second end of the inductor and another end coupled to an output voltage, the third and the fourth power switches operating in opposite phases to each other; and a control circuit generating only one set of constant time to control the operations of the four power switches such that the first and the third power switches operate by the same switching period with the same ON-time, and the second and the fourth power switches operate by the same switching period with the same ON-time.

The second or the fourth power switch can be replaced by a diode in the buck-boost switching regulator mentioned above.

The aforementioned constant time buck-boost switching regulator can be a current mode or a voltage mode, constant ON-time or constant OFF-time switching regulator.

From another perspective, the present invention provides a control circuit for controlling a constant time buck-boost switching regulator, wherein the buck-boost switching regulator includes an inductor, a first and a second power switches coupled to a first end and a second end of the inductor respectively, and a first and a second power devices coupled to the first end and the second end of the inductor respectively, the first power switch being coupled between the first end of the inductor and an input voltage, the second power switch being coupled between the second end of the inductor and ground, the first power device being coupled between the first end of the inductor and ground, and the second power device being coupled between the second end of the inductor and an output voltage, the control circuit comprising: an error amplifier for generating an error amplified signal by comparing a feedback signal relating to an output voltage with a reference voltage; only one PWM comparator for comparing a signal relating to an inductor current with the error amplified signal; a constant time generator for generating a constant time according to an output of the PWM comparator; and a driver circuit for generating a switch control signal to control the first and the second power switches according to an output of the constant time generator such that the first and the second power switches operate by the same switching period with the same ON-time.

From another perspective, the present invention provides a control circuit for controlling a constant time buck-boost switching regulator, wherein the buck-boost switching regulator includes an inductor, a first and a second power switches coupled to a first end and a second end of the inductor respectively, and a first and a second power devices coupled to the first end and the second end of the inductor respectively, the first power switch being coupled between the first end of the inductor and an input voltage, the second power switch being coupled between the second end of the inductor and ground, the first power device being coupled between the first end of the inductor and ground, and the second power device being coupled between the second end of the inductor and an output voltage, the control circuit comprising: an error amplifier for generating an error amplified signal by comparing a feedback signal relating to an output voltage with a reference voltage; only one PWM comparator for comparing a ramp signal with the error amplified signal; a constant time generator for generating a constant time according to an output of the PWM comparator; and a drive circuit for generating a switch control signal to control the first and the second power switches according to an output of the constant time generator such that the first and the second power switches operate by the same switching period with the same ON-time.

From another perspective, the present invention provides a control method for controlling a constant time buck-boost switching regulator, wherein the buck-boost switching regulator includes an inductor, a first and a second power switches coupled to a first end and a second end of the inductor respectively, and a first and a second power devices coupled to the first end and the second end of the inductor respectively, the first power switch being coupled between the first end of the inductor and an input voltage, the second power switch being coupled between the second end of the inductor and ground, the first power device being coupled between the first end of the inductor and ground, and the second power device being coupled between the second end of the inductor and an output voltage, the control method comprising: generating only one single constant time; and generating a switch control signal to control the first and second power switches according to the single constant time such that the first and the second power switches operate by the same switching period with the same ON-time.

The objectives, technical details, features, and effects of the present invention will be better understood with regard to the detailed description of the embodiments below.

### BRIEF DESCRIPTION OF THE DRAWINGS

FIG. 1 shows a conventional buck-boost switching regulator.

FIG. 2 shows the waveforms corresponding to the circuit of FIG. 1.

FIG. 3 shows another conventional buck-boost switching regulator.

FIG. 4 shows a state machine corresponding to the circuit of FIG. 3.

FIG. 5 shows waveforms of another prior art.

FIG. 6 shows another conventional buck-boost switching regulator.

FIG. 7 shows a first embodiment of the buck-boost switching regulator according to the present invention.

FIG. 8A and FIG. 8B show the operation of the first embodiment of the present invention.

FIG. 9 shows a second embodiment of the present invention.

FIG. 10 shows the waveforms corresponding to the circuit of FIG. 9.

FIG. 11 and FIG. 12 show two embodiments of voltage mode buck-boost switching regulators respectively.

FIG. 13 to FIG. 18 show several other embodiments of the present invention.

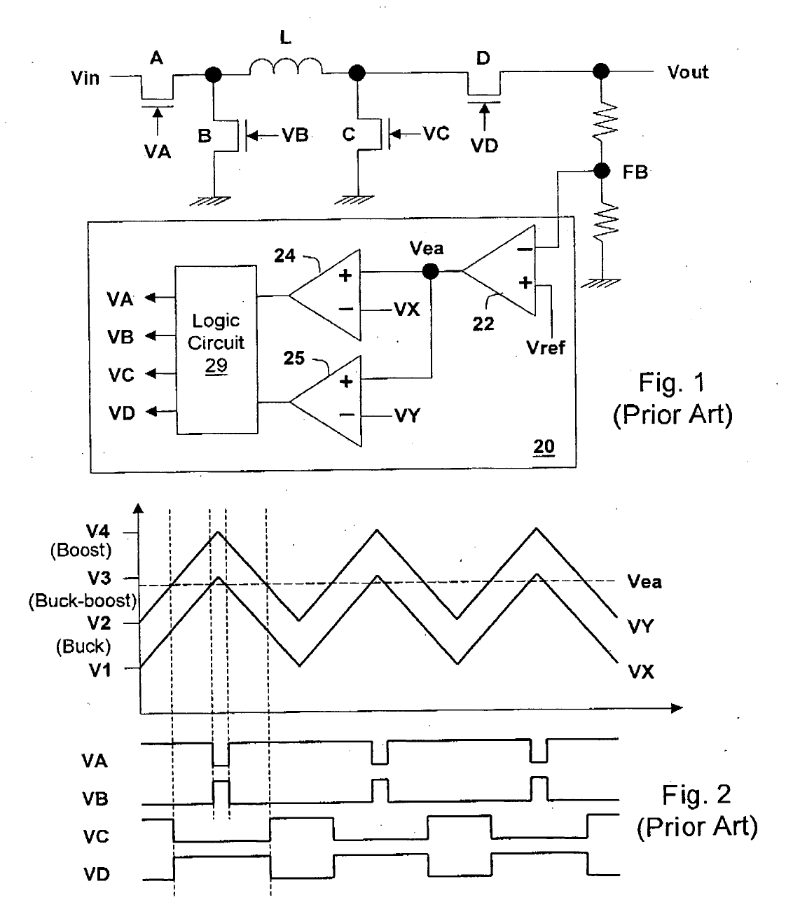

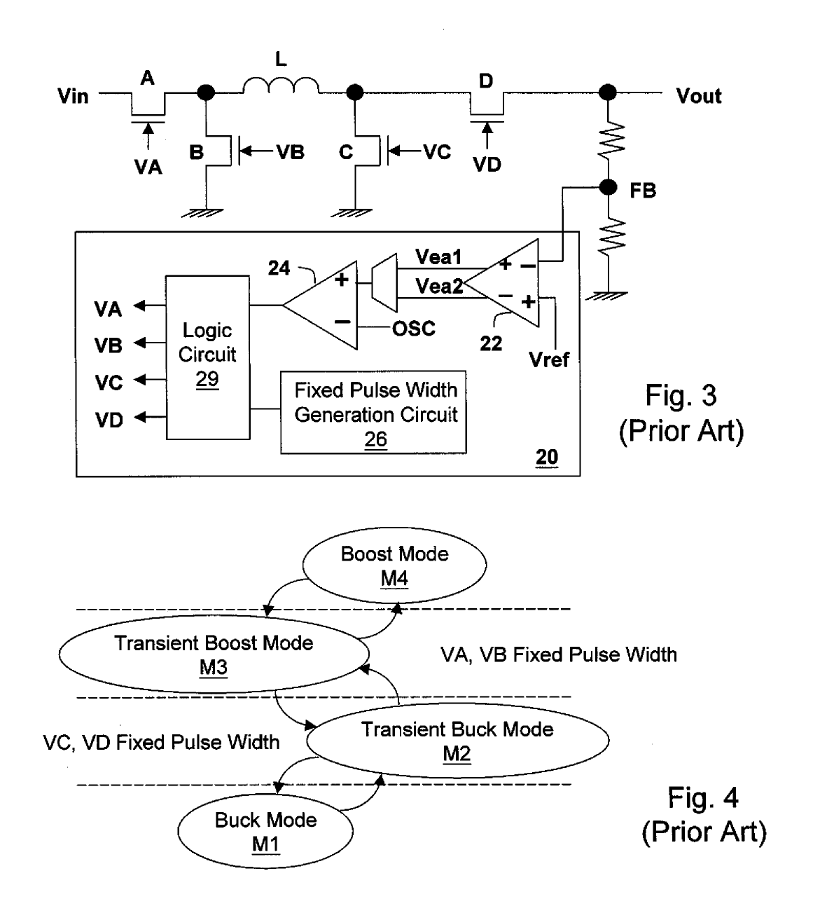

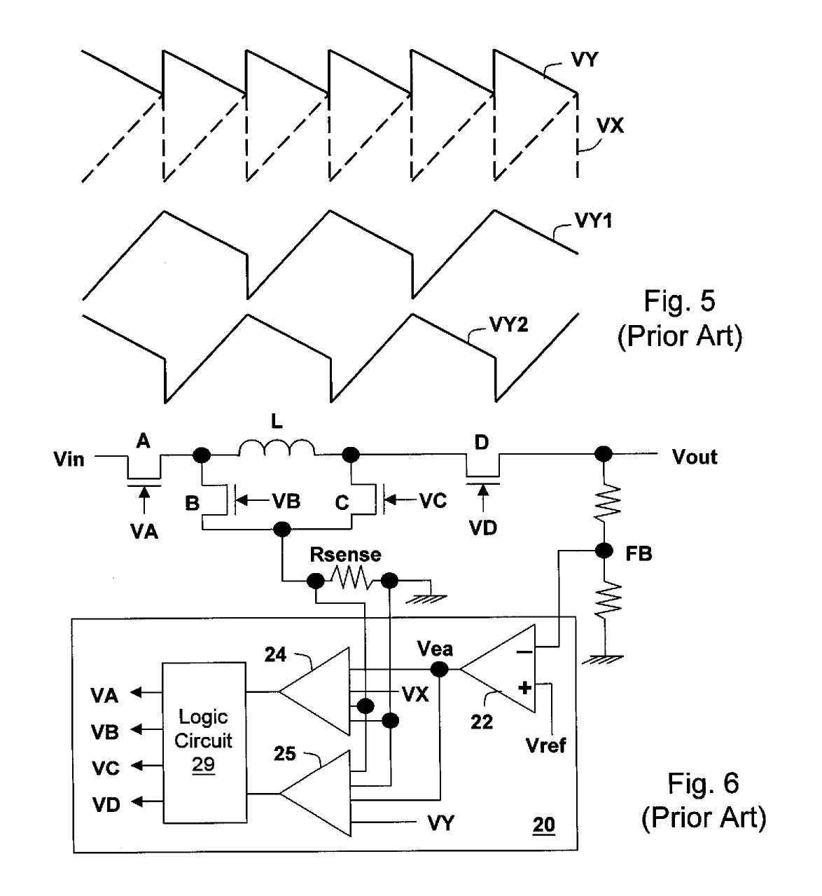

### DESCRIPTION OF THE PREFERRED EMBODIMENTS

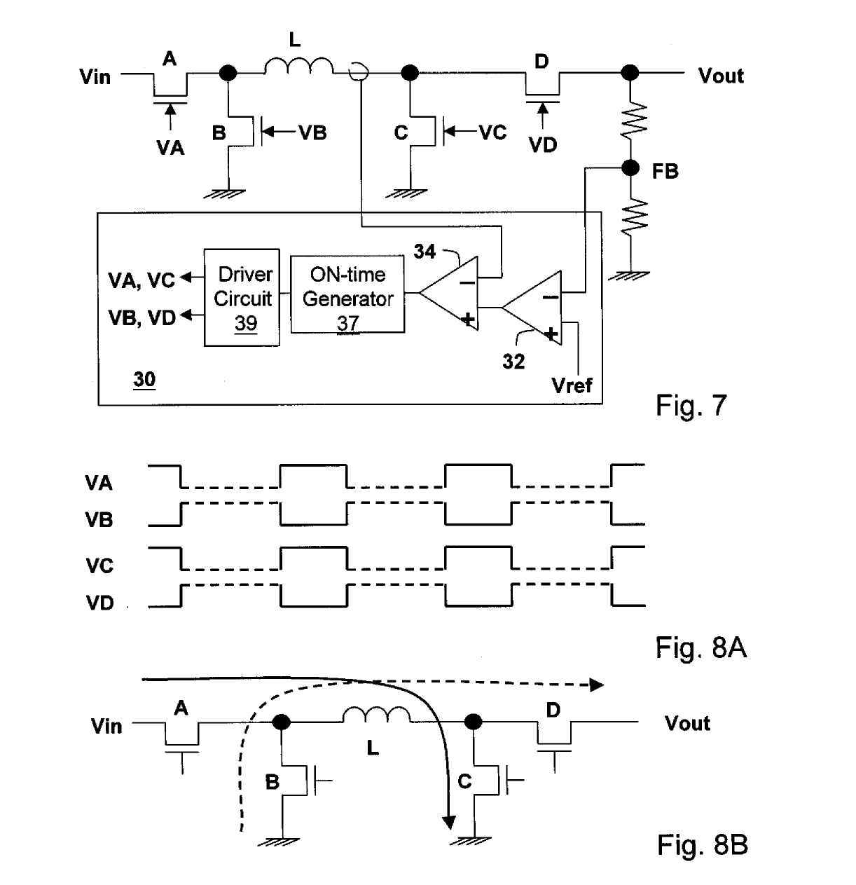

FIG. 7 shows a first embodiment of the present invention, with a current mode constant ON-time structure as an example. A buck-boost switching regulator in this embodiment comprises an inductor L, four power switches A, B, C and D, and a control circuit 30. The control circuit 30 controls the switching operations of the four power switches A, B, C and D to convert an input voltage Vin to an output voltage Vout. In the control circuit 30, the error amplifier 32 generates an error amplified signal by comparing a feedback signal FB (indicating information relating to the output voltage Vout) with the reference voltage Vref, and the error amplified signal is inputted to the PWM comparator 34. In addition, a signal relating to the inductor current is inputted to the PWM comparator 34, to be compared with the error amplified signal. An output of the PWM comparator 34 is transmitted to an ON-time generator 37 for generating switch ON-time. A driver circuit 39 generates switch control signals VA, VB, VC, and VD to control the power switches A, B, C, and D according to the ON-time.

The present invention is characterized in that only one PWM comparator 34 is required in the circuit, because only one set of ON-time is needed. Referring to FIG. 8A and FIG. 8B, in this embodiment, the switching periods and ON-time of the switching control signals VA and VC are substantially the same, and the switching periods and ON-time of switching control signals VB and VD are substantially the same. When the switching control signals VA and VC turn on the power switches A and C, the buck-boost switching regulator stores energy to the inductor L (solid line). And when the switching control signals VB and VD turn on the power switches B and D, the inductor L (solid line) releases energy. Because the ON-time of the switching control signals VA and VC is the same, and the switching control signals VB and VD are opposite in phase to VA and VC respectively, only one set of ON-time is required in the circuit. The hardware circuit and the mechanism are far simpler than the prior art circuits.

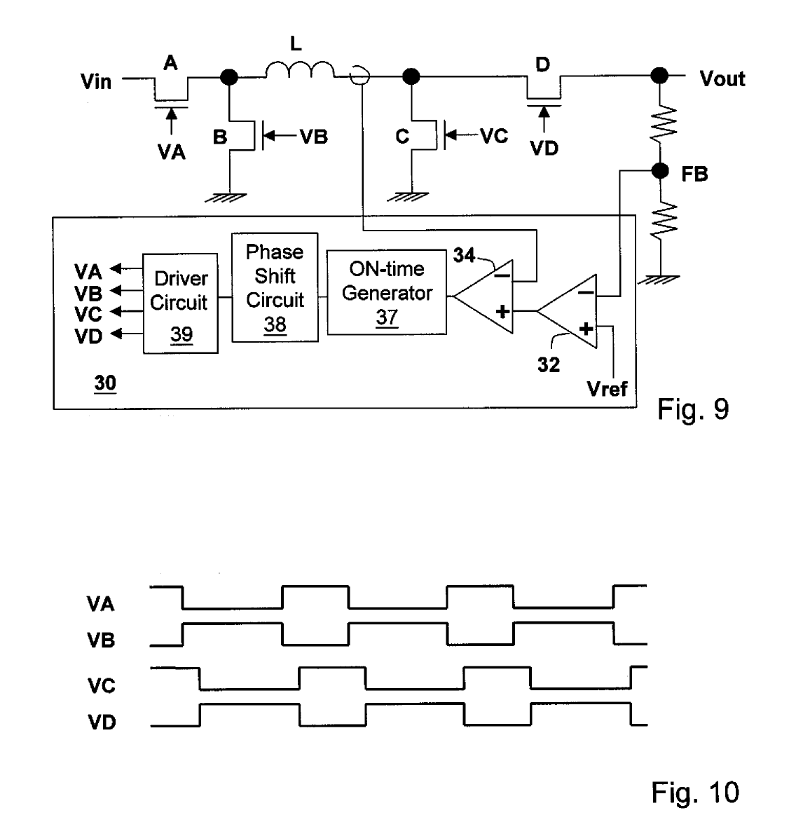

FIG. 9 and FIG. 10 show another embodiment of the present invention. In this embodiment, the switching periods and ON-time of the switching control signals VA and VC are substantially the same, but there is a phase shift between VA and VC. Similarly, the switching periods and ON-time of the switching control signals VB and VD are substantially the same, but there is a phase shift between VB and VD. The phase shift can be caused by device mismatching, or, as shown in FIG. 9, by the control of a phase shift circuit 38. Even though there is a phase shift between the switching control signals VA and VC (or VB and VD), the function of the circuit, i.e., buck-boost conversion is not impacted and still can be achieved.

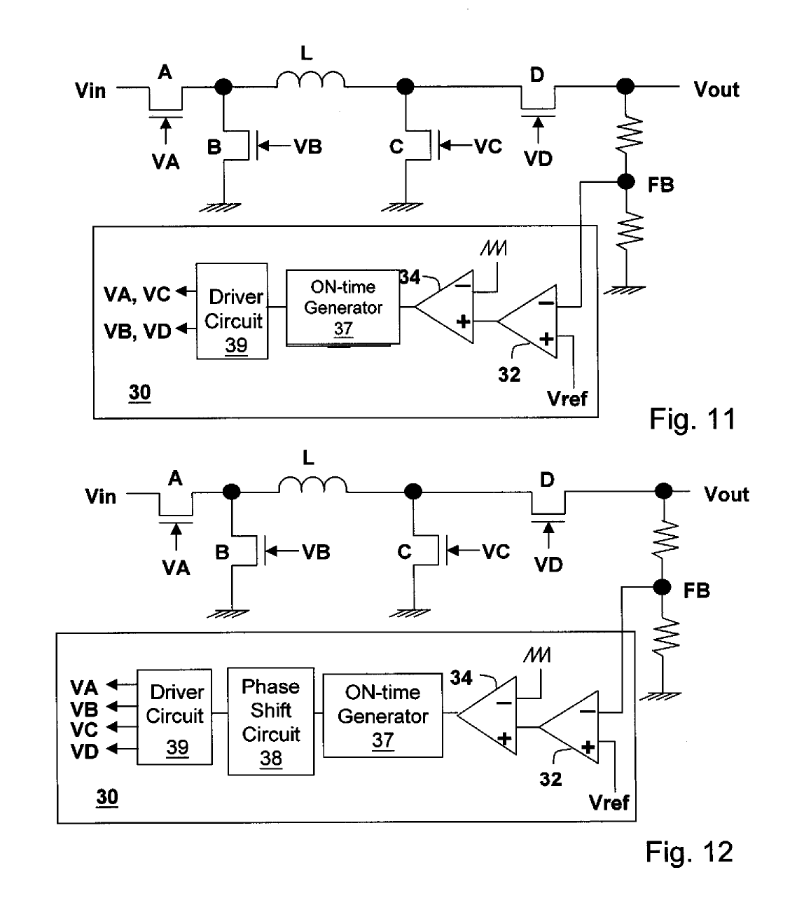

What FIG. 7 and FIG. 9 show are current mode switching regulators, but the present invention can also be applied to a voltage mode switching regulator. FIG. 11 and FIG. 12 show embodiments without phase shift and with phase shift between the switching control signals VA and VC (or the switching control signals VB and VD), respectively, wherein one input terminal of the PWM comparator 34 receives an error amplified signal, and another input terminal thereof receives a ramp signal generated by the internal circuit. The ramp signal can be of various forms and can be generated by various ways, as well known by those skilled in the art, so details thereof are omitted here.

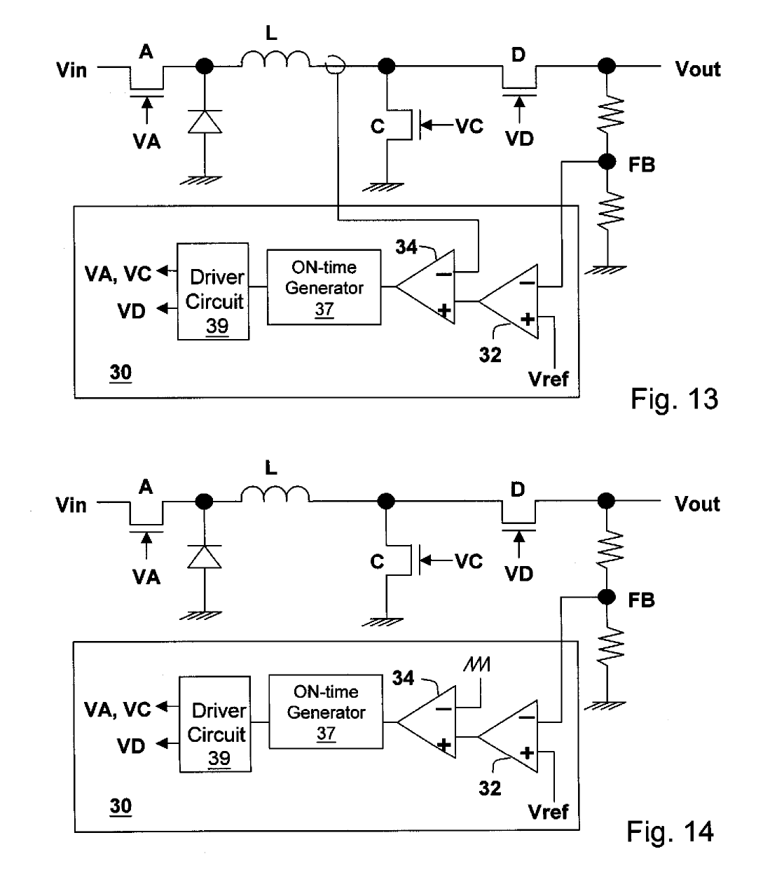

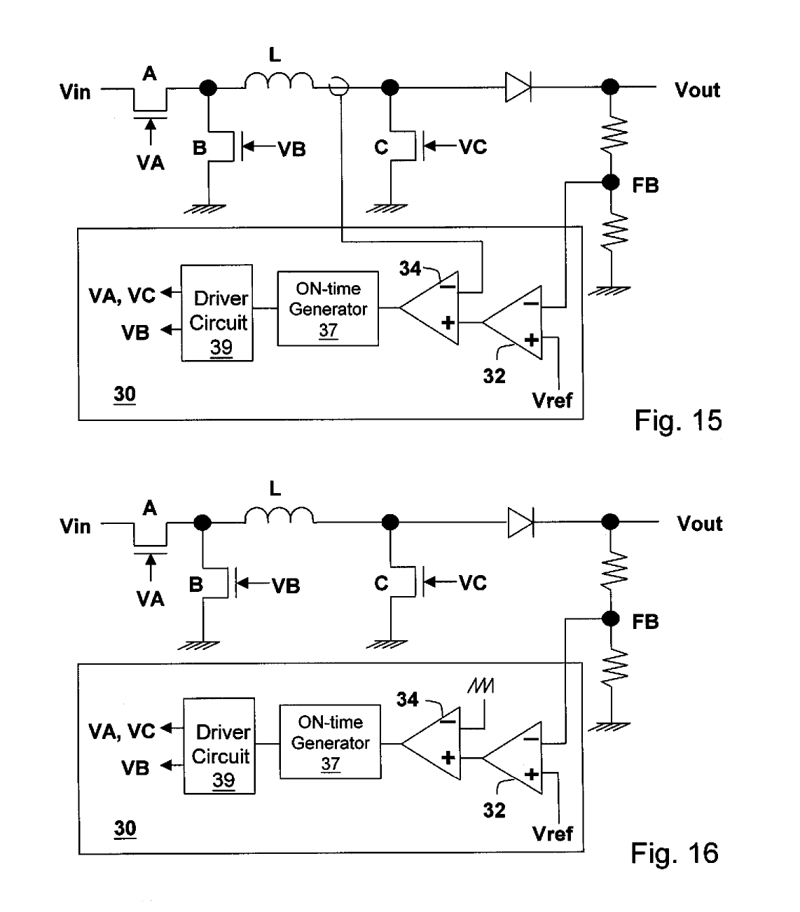

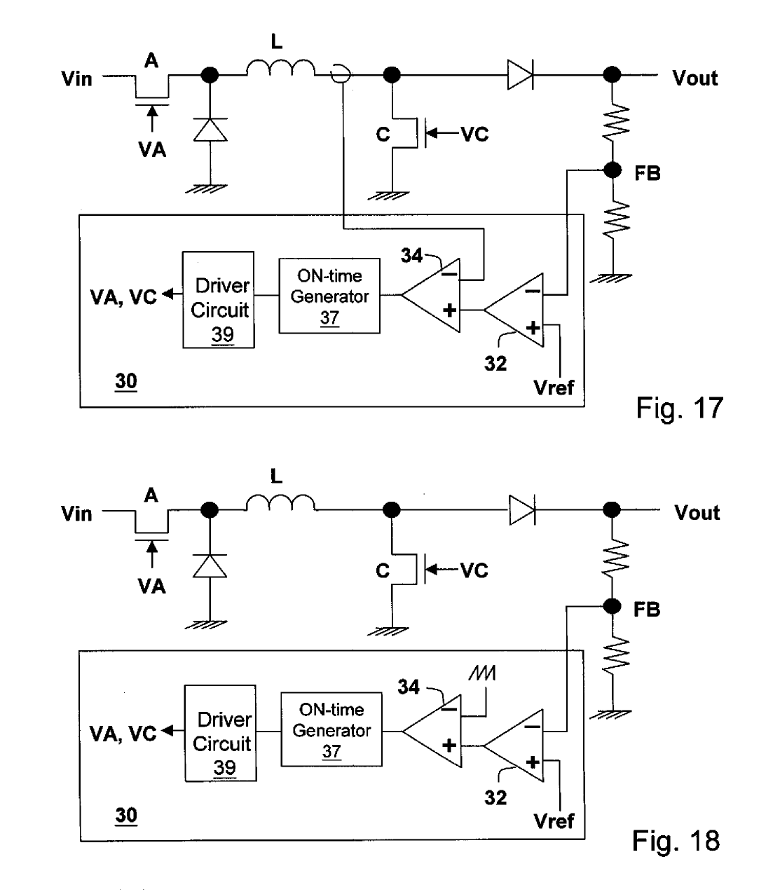

The present invention is not limited to a synchronous buck-boost switching regulator having four power switches. FIG. 13 to FIG. 18 show several more embodiments: FIG. 13 shows an embodiment of current mode buck-boost switching regulator and the power switch B is replaced by a diode. FIG. 14 shows an embodiment of voltage mode buck-boost switching regulator and the power switch B is replaced by a diode. FIG. 15 shows an embodiment of current mode buck-boost switching regulator and the power switch D is replaced by a diode. FIG. 16 shows an embodiment of voltage mode buck-boost switching regulator and the power switch D is replaced by a diode. FIG. 17 shows an embodiment of current mode buck-boost switching regulator and both the power switches B and D are replaced by diodes. FIG. 18 shows an embodiment of voltage mode buck-boost switching regulator and both the power switch B and D are also replaced by diodes. The present invention can be applied to all the aforementioned circuits, wherein only one PWM comparator 34 is used to generate only one set of constant time.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the power switches A, B, C, and D can be NMOSFET or PMOSFET, and the positive and negative input terminals of the PWM comparator 34 can be changed correspondingly. For another example, even though the embodiments in the present invention are described with reference to the “constant ON-time” structure, the same concept can certainly be applied to the “constant OFF-time” structure. In view of the foregoing, the spirit of the present invention should cover all such and other modifications and variations, which should be interpreted to fall within the scope of the following claims and their equivalents.

What is claimed is:

1. A constant time buck-boost switching regulator comprising:
an inductor having a first end and a second end;
a first power switch having one end coupled to the first end of the inductor and another end coupled to an input voltage;
a second power switch having one end coupled to the first end of the inductor and another end coupled to ground, the first and second power switches operating in opposite phases to each other;
a third power switch having one end coupled to the second end of the inductor and another end coupled to ground;
a fourth power switch having one end coupled to the second end of the inductor and another end coupled to an output voltage, the third and the fourth power switches operating in opposite phases to each other; and
a control circuit generating only one set of constant time to control the operations of the four power switches such that the first and the third power switches operate by the same switching period with the same ON-time, and the second and the fourth power switches operate by the same switching period with the same ON-time.

2. The switching regulator of claim 1, wherein there is a phase shift between the switching periods of the first and the third power switches, and there is another phase shift between the switching periods of the second and the fourth power switches.

3. The switching regulator of claim 1, wherein the control circuit includes:
an error amplifier for generating an error amplified signal by comparing a feedback signal relating to an output voltage with a reference voltage;
only one PWM comparator for comparing a signal relating to an inductor current with the error amplified signal;
a constant time generator for generating a constant time according to an output of the PWM comparator; and
a driver circuit for generating a switch control signal to control the first, the second, the third, and the fourth power switches according to an output of the constant time generator.

4. The switching regulator of claim 1, wherein the control circuit includes:
an error amplifier for generating an error amplified signal by comparing a feedback signal relating to an output voltage with a reference voltage;
only one PWM comparator for comparing a ramp signal with the error amplified signal;
a constant time generator for generating a constant time according to an output of the PWM comparator; and
a driver circuit for generating a switch control signal to control the first, the second, the third, and the fourth power switches according to an output of the constant time generator.

5. A constant time buck-boost switching regulator comprising:
an inductor having a first end and a second end;
a first power switch having one end coupled to the first end of the inductor and another end coupled to an input voltage;
a second power switch having one end coupled to the first end of the inductor and another end coupled to ground, the first and the second power switches operating in opposite phases to each other;
a third power switch having one end coupled to the second end of the inductor and another end coupled to ground;
a diode having one end coupled to the second end of the inductor and another end coupled to an output voltage; and
a control circuit generating only one set of constant time to control the operation of the first, the second, and the third power switches such that the first and the third power switches operate by the same switching period with the same ON-time.

6. The switching regulator of claim 5, wherein there is a phase shift between the switching periods of the first and the third power switches.

7. The switching regulator of claim 5, wherein the control circuit includes:
an error amplifier for generating an error amplified signal by comparing a feedback signal relating to an output voltage with a reference voltage;
only one PWM comparator for comparing a signal relating to an inductor current with the error amplified signal;
a constant time generator for generating a constant time according to an output of the PWM comparator; and
a driver circuit for generating a switch control signal to control the first, the second, and the third power switches according to an output of the constant time generator.

8. The switching regulator of claim 5, wherein the control circuit includes:
an error amplifier for generating an error amplified signal by comparing a feedback signal relating to an output voltage with a reference voltage;
only one PWM comparator for comparing a ramp signal with the error amplified signal;
a constant time generator for generating a constant time according to an output of the PWM comparator; and
a driver circuit for generating a switch control signal to control the first, the second, and the third power switches according to an output of the constant time generator.

9. A constant time buck-boost switching regulator comprising:
an inductor having a first end and a second end;
a first power switch having one end coupled to the first end of the inductor and another end coupled to an input voltage;
a diode having one end coupled to the first end of the inductor and another end coupled to ground;
a second power switch having one end coupled to the second end of the inductor and another end coupled to an output voltage;
a third power switch having one end coupled to the second end of the inductor and another end coupled to ground, the second and the third power switches operating in opposite phases to each other; and
a control circuit generating only one set of constant time to control the operation of the first, the second, and the third power switches such that the first and the third power switches operate by the same switching period with the same ON-time.

10. The switching regulator of claim 9, wherein there is a phase shift between the switching periods of the first and the third power switches.

11. The switching regulator of claim 9, wherein the control circuit includes:
an error amplifier for generating an error amplified signal by comparing a feedback signal relating to an output voltage with a reference voltage;
only one PWM comparator for comparing a signal relating to an inductor current with the error amplified signal;
a constant time generator for generating a constant time according to an output of the PWM comparator; and
a driver circuit for generating a switch control signal to control the first, the second, and the third power switches according to an output of the constant time generator.

12. The switching regulator of claim 9, wherein the control circuit includes:
an error amplifier for generating an error amplified signal by comparing a feedback signal relating to an output voltage with a reference voltage;
only one PWM comparator for comparing a ramp signal with the error amplified signal;
a constant time generator for generating a constant time according to an output of the PWM comparator; and
a driver circuit for generating a switch control signal to control the first, the second, and the third power switches according to an output of the constant time generator.

13. A constant time buck-boost switching regulator comprising:
an inductor having a first end and a second end;
a first power switch having one end coupled to the first end of the inductor and another end coupled to an input voltage;
a first diode having one end coupled to the first end of the inductor and another end coupled to ground;
a second power switch having one end coupled to the second end of the inductor and another end coupled to ground;
a second diode having one end coupled to the second end of the inductor and another end coupled to an output voltage; and
a control circuit generating only one set of constant time to control the operation of the first and the second power switches such that the first and the second power switches operate by the same switching period with the same ON-time.

14. The switching regulator of claim 13, wherein there is a phase shift between the switching periods of the first and the second power switches.

15. The switching regulator of claim 13, wherein the control circuit includes:
an error amplifier for generating an error amplified signal by comparing a feedback signal relating to an output voltage with a reference voltage;
only one PWM comparator for comparing a signal relating to an inductor current with the error amplified signal;
a constant time generator for generating a constant time according to an output of the PWM comparator; and
a driver circuit for generating a switch control signal to control the first and the second power switches according to an output of the constant time generator.

16. The switching regulator of claim 13, wherein the control circuit includes:
an error amplifier for generating an error amplified signal by comparing a feedback signal relating to an output voltage with a reference voltage;
only one PWM comparator for comparing a ramp signal with the error amplified signal;
a constant time generator for generating a constant time according to an output of the PWM comparator; and
a driver circuit for generating a switch control signal to control the first and the second power switches according to an output of the constant time generator.

17. A control circuit for controlling a constant time buck-boost switching regulator, wherein the buck-boost switching regulator includes an inductor, a first and a second power switches coupled to a first end and a second end of the inductor respectively, and a first and a second power devices coupled to the first end and the second end of the inductor respectively, the first power switch being coupled between the first end of the inductor and an input voltage, the second power switch being coupled between the second end of the inductor and ground, the first power device being coupled between the first end of the inductor and ground, and the second power device being coupled between the second end of the inductor and an output voltage, the control circuit comprising:
an error amplifier for generating an error amplified signal by comparing a feedback signal relating to an output voltage with a reference voltage;
only one PWM comparator for comparing a signal relating to an inductor current with the error amplified signal;
a constant time generator for generating a constant time according to an output of the PWM comparator; and
a driver circuit for generating a switch control signal to control the first and the second power switches according to an output of the constant time generator, such that the first and the second power switches operate by the same switching period with the same ON-time.

18. The control circuit of claim 17, wherein there is a phase shift between the switching periods of the first and the second power switches.

19. A control circuit for controlling a constant time buck-boost switching regulator, wherein the buck-boost switching regulator includes an inductor, a first and a second power switches coupled to a first end and a second end of the inductor respectively, and a first and a second power devices coupled to the first end and the second end of the inductor respectively, the first power switch being coupled between the first end of the inductor and an input voltage, the second power switch being coupled between the second end of the inductor and ground, the first power device being coupled between the first end of the inductor and ground, and the second power device being coupled between the second end of the inductor and an output voltage, the control circuit comprising:
an error amplifier for generating an error amplified signal by comparing a feedback signal relating to an output voltage with a reference voltage;
only one PWM comparator for comparing a ramp signal with the error amplified signal;
a constant time generator for generating a constant time according to an output of the PWM comparator; and
a driver circuit for generating a switch control signal to control the first and the second power switches according to an output of the constant time generator, such that the first and the second power switches operate by the same switching period with the same ON-time.

20. The control circuit of claim 19, wherein there is a phase shift between the switching periods of the first and the second power switches.

21. A control method for controlling a buck-boost switching regulator, wherein the buck-boost switching regulator includes an inductor, a first and a second power switches coupled to a first end and a second end of the inductor respectively, and a first and a second power devices coupled to the first end and the second end of the inductor respectively, the first power switch being coupled between the first end of the inductor and an input voltage, the second power switch being coupled between the second end of the inductor and ground, the first power device being coupled between the first end of the inductor and ground, and the second power device being coupled between the second end of the inductor and an output voltage, the control method comprising:
generating only one single constant time; and
generating a switch control signal to control the first and second power switches according to the single constant time such that the first and the second power switches operate by the same switching period with the same ON-time.

22. The control method of claim 21, wherein the step of generating only one single constant time includes:
generating an error amplified signal by comparing a feedback signal relating to an output voltage with a reference voltage; and
generating the only one single constant time by comparing a signal relating to an inductor current with the error amplified signal.

23. The control method of claim 21, wherein the step of generating only one single constant time includes:
generating an error amplified signal by comparing a feedback signal relating to an output voltage with a reference voltage; and
generating the only one single constant time by comparing a ramp signal with the error amplified signal.

24. The control method of claim 21, wherein there is a phase shift between the switching periods of the first and the second power switches.
